(19) United States
(12) Patent Application Publication
(10) Pub. No.: US 2002/0019291 A1
(43) Pub. Date: Feb. 14, 2002

(54) Control system and control method for internal combusion engine

(75) Inventor: Yasushi Ito, Susono-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOYOTA JIDOSHA KABUSHIKI KAISHA, TOYOTA-SHI (JP)

(21) Appl. No.: 09/918,833

(22) Filed: Aug. 1, 2001

(30) Foreign Application Priority Data
Aug. 2, 2000 (JP) 2000-238887

(51) Int. Cl. B60K 41/28

(52) U.S. Cl. 477/92; 123/347; 123/350; 477/111; 477/203; 477/107

(57) ABSTRACT

A control system and a control method for an internal combustion engine employs an electronic control unit (ECU) in the internal combustion engine to control an output torque of the engine. The ECU anticipates that a driver will make an engine output torque change request based on an operation of an automatic transmission performed by the driver, a brake pedal operation performed by the driver, a vehicle speed detected by a vehicle speed sensor and other information, and changes in advance an amount of engine intake air, a throttle valve opening, an engine speed and other engine operating parameters that determine the engine output according to the engine output change request made by the driver. This allows even an engine operating parameter that is slow to change to be changed to a value close to that after the engine output torque has been changed. This in turn allows the engine output torque to be changed within a shorter period of time in accordance with the engine output change request made by the driver, contributing to a better response.

### INCORPORATION BY REFERENCE

The disclosure of Japanese Patent Application No. 2000-238887 filed on Aug. 2, 2000 including the specification, drawings and abstract is incorporated herein by reference in its entirety.

### BACKGROUND OF THE INVENTION

1. Field of the Invention

The invention relates to a control system for internal combustion engines. More particularly, the invention relates to a control system for internal combustion engines that controls engine operating parameters determining an engine output torque according to an engine output torque request made by a driver, and a control method for the same.

2. Description of the Related Art

An so-called torque demand control for internal combustion engines is known, in which a target output torque to be generated by the engine is calculated based on an accelerator operation by the driver and an amount of engine intake air, ignition timing, amount of fuel injected, and other engine operating parameters that determine the engine output so as to obtain the target output torque. Since each of these engine operating parameters is set and controlled in accordance with the engine output torque in the torque demand control, engine controllability, including air-fuel ratio control and engine output torque control, is enhanced.

For example, Japanese Patent Laid-Open Publication HEI 11-82090 discloses a control system for internal combustion engines that provides control of this sort.

In the control system disclosed in this publication, a target output torque of the engine is first calculated based on the accelerator operation by the driver and the engine operating conditions, and the amount of intake air, the amount of fuel injected, and the ignition timing are determined so as to obtain the target torque.

In the torque demand control disclosed in HEI 11-82090, however, the target output torque of the engine is first calculated based on the amount of accelerator operation by the driver after the driver has operated the accelerator, and then the amount of engine intake air and other engine operating parameters are controlled so as to obtain the calculated target output torque. This results in a certain time lag between the time when the driver operates the accelerator and the time when the engine output torque is actually generated. Especially with a case in which there are great changes involved in engine operating parameters, such as when a vehicle is started or when an operating phase changes from deceleration to acceleration, the time lag involved between the time when the driver operates the accelerator and the time when the engine output torque is actually boosted up becomes longer, which could aggravate the response lag in engine output torque control.

### SUMMARY OF THE INVENTION

In view of the foregoing, it is an object of this invention to provide a control system for internal combustion engines capable of enhancing response in actual engine output torque changes to a request made by the driver to change the engine output.

The control system for internal combustion engines according to a first aspect of the invention anticipates that there will be an engine output torque change request by the driver based on engine operating conditions and, when an engine output torque change request by the driver is anticipated, performs a standby operation that changes at least one of the engine operating parameters before the request for an engine output torque change is made.

Namely, if an engine output torque change request by the driver is anticipated, the value of at least one of the engine operating parameters is changed so as to shorten a time required for an engine output torque change before the request for an engine output torque change is actually made. For example, if it is anticipated that there will be a request for an increased engine output torque made by the driver, an engine operating parameter, such as the amount of engine intake air, is changed in advance for an increased torque (in a direction of an greater amount of intake air). When there is actually a request made by the driver for an output torque change, therefore, the engine operating parameters are already closer to those states present after the torque is changed, which makes it possible to change the output torque to a value corresponding to the request made by the driver within a shorter period of time after the output change request is actually made by the driver, thus contributing to a better response in torque control.

The control system for internal combustion engines according to a second aspect of this invention is provided with a torque change device that performs a torque change operation that changes the engine output torque by changing a plurality of engine operating parameters determining the engine output torque in accordance with a request made by the driver for an engine output torque change. The engine operating parameters include a first engine operating parameter that can be changed within a relatively short period of time according to a change command issued by the torque change device and a second engine operating parameter that requires a relatively long period of time to change. The torque change device performs a standby operation that causes the second engine operating parameter to start changing according to the driver's engine output torque change request and, thereafter causes the first engine operating parameter to start changing. At the end of the torque change operation, the change in the first engine operating parameter and the second engine operating parameter completes. Thereby, it controls the engine output torque at the end of the torque change operation to a value corresponding to the engine output torque request.

According to the second aspect of the invention, a change for the second engine operating parameter that has a lower response to change is first started before the torque change operation is initiated. This actually initiates the torque change control and it means that, when the first engine operating parameter having a higher response starts changing, the second engine operating parameter is already in the middle of the change, which allows both the first and the second engine operating parameters to change the engine output torque within a shorter period of time. In addition, at the end of the torque change operation, control is provided to change the first engine operating parameter having a higher response to bring the engine output torque to a value corresponding to the request, thus permitting highly accurate control of output torque.

The internal combustion engine transmits the torque to an output shaft through a transmission and the torque change operation may be executed at the time of gearshift operation of the transmission.

Namely, since the torque change operation is executed when a gearshift operation of the transmission is made, a highly responsive, smooth engine output torque control can be provided at the time that a gearshift operation is executed.

The first engine operating parameter may be either an engine ignition timing or an amount of fuel injected or both, while the second engine operating parameter may be either an amount of engine intake air or an engine valve timing or both.

Namely, since either the engine ignition timing or the amount of fuel injected, or both, are used as the first engine operating parameter having a higher response and either the amount of engine intake air or the engine valve timing, or both, are used as the second engine operating parameter having a lower response, the engine output is controlled to offer a good response and a high accuracy at the time of a torque change operation.

The embodiments of the invention are not limited to the control systems for internal combustion engines described in the foregoing. Another aspect of this invention may be a vehicle mounted with the control system according to this invention or a control method for internal combustion engines.

### BRIEF DESCRIPTION OF THE DRAWINGS

FIG. 1 is a block diagram showing a configuration of an embodiment of the invention in an automobile internal combustion engine.

FIG. 2 is a flow chart explaining one embodiment of the standby operation according to the control system of this invention.

FIG. 3 is a flow chart explaining another embodiment that is different from FIG. 2 of the standby operation according to the control system of this invention.

FIG. 4 is a flow chart explaining an embodiment that is different from FIG. 2 or FIG. 3 of the standby operation according to the control system of this invention.

### DETAILED DESCRIPTION OF THE PREFERRED EMBODIMENTS

Preferred embodiments of the invention will be explained with reference to the drawings.

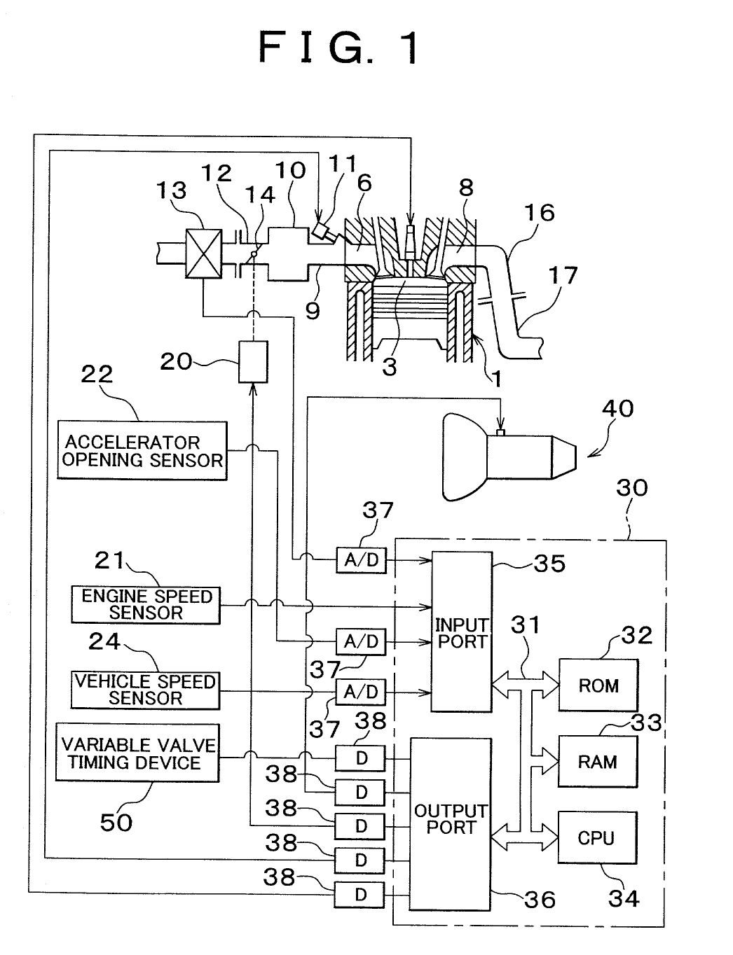

FIG. 1 is a block diagram showing a configuration of an embodiment of the invention embodied in an automobile internal combustion engine. A gasoline engine is used as an internal combustion engine 1 according to this embodiment as shown in FIG. 1. Referring to FIG. 1, the internal combustion engine is provided with a combustion chamber 2 of the engine 1 and intake ports 6 and exhaust ports 8 of the engine. While each of the intake ports 6 is connected to a surge tank 10 through an intake branch pipe 9, a fuel injection valve 11 that injects fuel to each intake port 6 is disposed at each of the branch pipes 9. The fuel injection valve 11 may be a cylinder injection type that injects fuel directly into the cylinder combustion chamber.

The surge tank 10 is connected via an intake passage 12 to an air cleaner, and a throttle valve 14 is disposed in the intake passage 12. The throttle valve 14 according to this embodiment is an electronically controlled throttle valve that is provided with a stepping motor or an actuator 20 of any other appropriate type operating in accordance with a command given by an electronic control unit (ECU) 30, to be explained later, and opens to an angle according to the command signal from the ECU 30.

The exhaust port 8 of the engine 1 is connected to an exhaust passage 17 through an exhaust manifold 16. An air flow meter 13 detects the amount of engine intake air on the upstream side of the throttle valve 14 of the intake passage 12. The air flow meter 13 may be a vane type provided with a potentiometer, a hotwire flow meter type, an ultrasonic type, a Karman vortex flow meter type, or the like.

An automatic transmission 40 is connected to an output shaft (not shown) of the engine 1 as shown in FIG. 1. The automatic transmission 40 according to this embodiment is provided with a fluid torque converter, and an output shaft of the transmission is connected to a drive wheel through a differential gear not shown.

In addition to the type with a fluid torque converter, the automatic transmission may be a mechanical continuously variable transmission (CVT) or a multi-mode transmission (MMT) that automatically performs a gearshift operation as a gearshift lever is operated by the driver.

In the present embodiment, there is also provided a variable valve timing device 50 that can vary the valve timing of the engine 1 during operation. In this embodiment, the valve timing of either an intake valve or an exhaust valve, or both, is varied by changing the revolution phase of either an intake cam or an exhaust cam, or both, with respect to an engine crankshaft. The invention does not, however, limit the type used for the variable valve timing device 50. Any type will do as long as it can vary the open/close timing of the intake valve or the exhaust valve while the engine is running.

The electronic control unit (ECU) 30 of the engine 1 comprises a microcomputer of a known arrangement in which a ROM (read-only memory) 32, a RAM (random-access memory) 33, a CPU (microprocessor) 34, an input port 35 and an output port 36 are mutually connected through a bidirectional bus 31. The ECU 30 controls the amount of fuel injected, the ignition timing, the amount of intake air and other engine operating parameters that determine the engine output torque to provide a torque control that controls the engine output torque to be the target output torque. Not only that, but it also performs a gearshift control that controls the gearshift operation of the automatic transmission 40 according to the vehicle running conditions. In addition to these controls, the ECU 30 according to the present embodiment performs a standby operation, to be explained later, in which it anticipates that there will be a request for an engine output torque change by the driver and, before the request for an engine output torque change is actually made, changes a value of an engine operating parameter in accordance with the anticipated output change.

To achieve the foregoing object, a voltage signal representing a vehicle running speed from a vehicle speed sensor 24 and a voltage signal representing the amount of engine intake air from the air flow meter 13 are input to the input port 35 of the control circuit 30 through an AD converter 37. In addition, a pulse signal representing an engine speed is applied from an engine speed sensor 21 provided on the crankshaft (not shown) of the engine. Furthermore, an accelerator opening sensor 22 is provided near an accelerator pedal (not shown) on the driver's seat according to the present embodiment. It supplies the input port of the ECU 30 with a voltage signal corresponding to the amount of accelerator pedal operated by the driver (accelerator opening) through the AD converter 37.

The output port 36 of the control circuit 30 is connected to a control valve controlling the gearshift operation of the automatic transmission 40 through driver circuits 38, thus allowing the gearshift operation to be controlled. In addition, it is connected by way of the respective driver circuits 38 to the fuel injection valve 11, an ignition plug, the throttle valve actuator 20 and the variable valve timing device 50, which allows the amount of fuel injected from the fuel injection valve 11, engine ignition timing, throttle valve 14 opening, and the engine valve timing to be controlled.

The engine output torque control according to the present embodiment will be explained. In the present embodiment, the same engine output torque control as that disclosed in the Japanese Patent Laid-Open Publication HEI 11-82090 is provided. Namely, the ECU 30 calculates the target output torque of the engine 1 based on the amount of accelerator pedal depression by the driver (accelerator opening) as detected by the accelerator opening sensor 20 and, while the engine is running, controls the amount of engine intake air, the amount of fuel injected, the ignition timing, the valve timing and other engine operating parameters to ensure that the target output torque is obtained.

As explained in the foregoing, it is possible to provide a highly accurate engine output torque control by first calculating the target output torque based on the accelerator opening and then setting the engine operating parameters based on the target output torque obtained through calculation. In actual operations, however, when the driver requires a sudden boost in engine output torque, such as when starting the vehicle, re-accelerating the vehicle from a decelerated state or making a gearshift operation of the automatic transmission, the engine output torque may not be boosted as quickly as the driver expects it to, responding only poorly to the requirement. Namely, when, for example, the vehicle is to be started, the driver expects that the engine output torque will be augmented as soon as he or she depresses the accelerator pedal. In the foregoing torque control, however, the calculation of the target output torque and the change of engine operating parameters corresponding to the calculated target output torque are started only after the driver has depressed the accelerator pedal (that is, after a request has been made for an increased output torque by the driver).

In this case, the engine operating parameters such as the engine ignition timing and the amount of fuel injected can quickly change in response to a control command issued by the ECU 30 to reach the values corresponding to the target output torque within a shorter period of time. However, the amount of engine intake air, the engine valve timing, and related engine operating parameters are unable to quickly change, taking a relatively long time to reach the values corresponding to the target output torque. In order for the engine output torque to reach the target torque level, however, it is necessary that each and every one of the engine operating parameters change to the value corresponding to the target output torque. This means that it takes some time before an engine output torque expected by the driver is obtained after a request for an increased engine output torque has been made by the driver (the driver has depressed the accelerator pedal), resulting in the acceleration performance and response being deteriorated.

According to the present embodiment, therefore, when an engine output torque change request by the driver is anticipated, a standby operation is performed in which at least the values of part of the engine operating parameters are changed in advance according to the anticipated request for an engine output torque change. This allows all of the engine operating parameters to reach the values corresponding to the engine output torque change request within a shorter period of time when such a request is actually made, which contributes to an enhanced acceleration performance and response. In a standby operation embodiment to be explained in the following, the values of the engine operating parameters requiring a longer period of time to change, such as the amount of engine intake air and valve timing, are changed before an output torque change request is actually made, thereby improving output torque control response by a large margin.

Embodiments of the standby operations performed when the vehicle is started, when the vehicle is re-accelerated from a decelerated state and when a gearshift operation is performed are explained in the following.

(1) Standby Operation when the Vehicle is Started

In the present embodiment, it is anticipated that the driver will perform an operation to start the vehicle and a standby operation is carried out in advance in which the engine speed, throttle valve opening, engine valve timing and other operating parameters are set on the side of values for an increased torque. To prevent the engine output torque from being augmented to an unexpectedly large level during the standby operation, which occurs as a result of the operating parameters being set on the side of values for an increased torque, the engine ignition timing is retarded at the same time, thereby controlling the degree of increase in the output torque.

In the operation to start the vehicle, the driver places the transmission in the running range from a neutral state and releases a vehicle brake before depressing the accelerator pedal. This very depressing operation of the accelerator pedal is the request made by the driver for an increased output torque. In the present embodiment, therefore, the standby operation is performed in anticipation of an accelerator pedal operation (an engine output torque increase request) if: (1) while the engine is running at idle speed with the vehicle at a standstill, (2) the transmission is placed in the running range and, at the same time, (3) the vehicle brake is released.

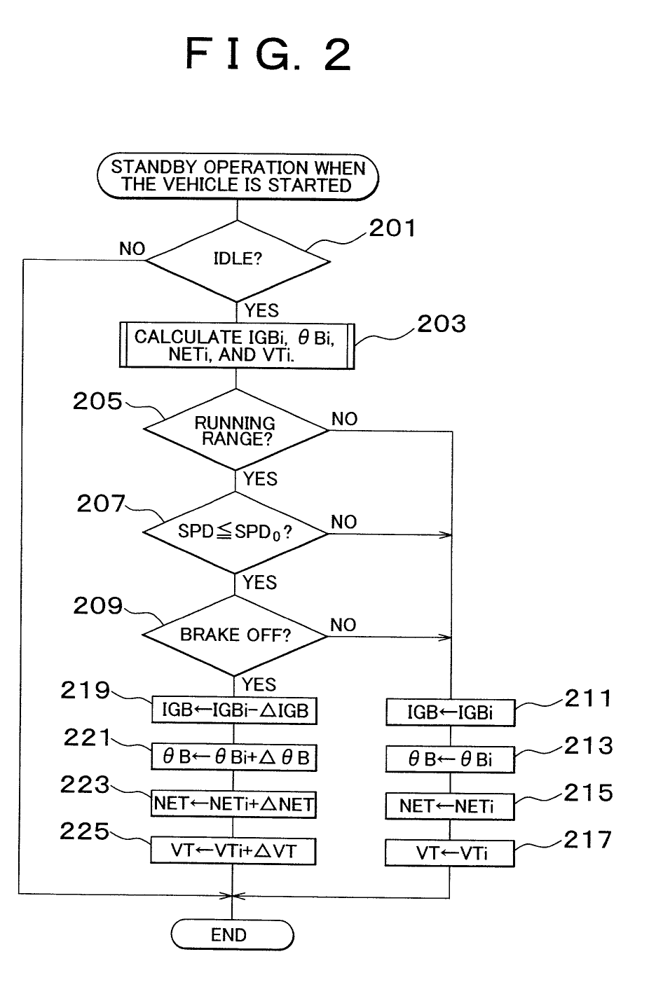

FIG. 2 is a flow chart explaining the standby operation according to the present embodiment. This operation is performed as a routine executed at predetermined time intervals by the ECU 30.

When the operation shown in FIG. 2 is started, it is determined whether the engine 1 is currently running at idle speed or not in step 201. In the present embodiment, it is determined that the engine is running at idle speed if the amount of the accelerator pedal operated by the driver (accelerator opening) is zero and, at the same time, the throttle valve opening is zero.

If it is determined that the engine is not running at idle speed in step 201, the execution of the current operation is terminated without performing the standby operation.

If it is determined that the engine is currently running at idle speed in step 201, a basic ignition timing IGBi, a basic throttle valve opening θBi, a target engine speed NETi, and a valve timing VTi during the idle operation are determined in step 203. The values of IGBI, θBi, NETI, and VTi represent the engine operating parameter values that are optimum for idle operations and have been previously stored in the ROM of the ECU 30.

It is then determined in step 205 whether the transmission is now placed in the running range or not, whether the vehicle is now at a standstill or not [whether the current vehicle speed detected by the vehicle speed sensor 24 is at or smaller than a predetermined small value SPD₀ (e.g., SPD₀=: 2 km/h) or not] in step 207, and in step 209 whether the amount of the brake pedal operated is now zero or not (whether the vehicle brake is released or not).

When the determinations of steps 205 to 209 are negative, namely if the transmission is not placed in the running range (the transmission is placed in the neutral position), the vehicle is not at a standstill or the brake is not released, it can be considered that the driver is not about to attempt to start the vehicle and there will not be an imminent request for an increased engine output torque. Thus, no standby operation is performed.

In this case, the basic ignition timing IGB, the basic throttle valve opening θB, the engine target speed NET and the valve timing VT are set in steps 211 to 217 to the ordinary idling values of IGBI, θBi, NETi and VTi, respectively, determined in step 203. When the basic ignition timing IGB and the basic throttle valve opening θB are set in steps 211 and 213, an ignition timing setting operation and a throttle valve opening setting operation, which are separately performed by the ECU 30 and which are not shown, compute an actual engine ignition timing and an actual throttle valve opening by adding a correction amount corresponding to the engine operating conditions (warm-up condition, operation ofaccessories, etc.) to the set basic ignition timing IGB and the basic throttle valve opening θB. Further, the engine target speed NET is set to the idling target engine speed NETi and the valve timing VT is set to the idling valve timing VTi.

If all of the conditions from step 205 to step 209 are met, namely if the engine is running at idle speed, the vehicle is at a standstill (step 207), the transmission is placed in the running range (step 205) and the brake is released (step 209), it is anticipated that the driver will subsequently attempt to depress the accelerator pedal, that is, a request will be made by the driver for an engine output boost. In this case, therefore, the standby operation from steps 219 to 225 is performed.

In the standby operation according to the present embodiment, the engine basic ignition timing IGB is set in step 219 to a value (IGB=IGBi−ΔIGB) which is retarded by a predetermined value of ΔIGB with respect to the idling basic ignition timing IGBi set in step 203. In step 221, the basic throttle valve opening θB is set to a value which is the idling basic throttle valve opening θBi, increased by a predetermined value of ΔθB. In step 223, the engine target speed NET is set to a value which is the idling target engine speed NETi increased by a predetermined value of ANET. In step 225, the valve timing VT is set to a value which is advanced by a predetermined value of ΔVT with respect to the idling valve timing VTi.

The reason why the basic throttle valve opening θB is increased (in step 221) is to increase the amount of intake air, which takes a relatively long time to change, before a request is made by the driver for an increased output torque. The reason why the valve timing VT is advanced (in step 225) is to change in advance the valve timing, which takes a long time to change, toward the side for an increased output torque. Further, the reason why the engine speed is increased is to increase the amount of engine intake air, and to increase the operating speed of the variable valve timing device by increasing the speed of a hydraulic pump that drives the engine output shaft for a boosted hydraulic pressure for driving the variable valve timing device.

In addition, the reason why the ignition timing is retarded in step 219 is to prevent the output torque from being augmented before a request is actually made for an engine output torque boost, which occurs as a result of an increased amount of engine intake air, an increased engine speed and a changed valve timing.

In the foregoing embodiment, if it is anticipated that the driver will make a request for an engine output torque boost, the standby operation is executed by increasing the amount of engine intake air and, at the same time, retarding the engine ignition timing before the request for an engine output torque boost is actually made. It takes time for the amount of engine intake air to change and therefore, if a sequence is started to change the amount of intake air after the request for an engine output torque boost has been actually made, it will take excessive time to actually increase the engine output torque. Since the amount of engine intake air is increased in advance in anticipation of an output torque boost request, however, it is possible to increase the engine torque within a shorter period of time after the output torque boost request is actually later made. In addition, if the amount of engine intake air is increased before the output torque boost request is actually made, it results in the engine output torque being increased before the output torque boost request is actually made. The standby operation according to this embodiment prevents this from occurring by retarding the engine ignition timing as the engine output is increased. This effectively prevents the output torque from being increased before the output torque boost request is actually made. After the output torque boost request is made by the driver, the engine ignition timing is advanced and, moreover, since it is possible to change the engine ignition timing within an extremely short period of time, the response lag would not be aggravated even if a sequence to change the ignition timing is started after the output torque boost request is made by the driver.

When it is anticipated that the driver will make a request for an engine output torque boost, the standby operation is executed by increasing the engine speed. Increasing the engine speed will increase the amount of engine intake air even with the same throttle opening. This allows the engine torque to be increased within a shorter period of time after the output torque boost request has been actually made. In an engine employing a hydraulically driven variable valve timing device to vary the engine valve timing, increasing the engine speed will increase the discharge pressure and the flow rate of a hydraulic pump driven by the engine, which increases the operating speed of the variable valve timing device. As a result, the rate of change in the valve timing becomes higher when the valve timing is varied toward a side for an increased output torque, which makes it possible to increase the engine output torque within a shorter period of time.

When it is anticipated that the driver will make a request for an engine output torque boost, the standby operation is executed by changing the engine valve timing to a value for an increased engine output torque. In an engine provided with a variable valve timing device, the engine output torque is changed by varying the engine valve timing. The operating speed of the variable valve timing device is usually not very high. It therefore takes a long time for the engine output torque to actually increase after an output torque increase request has been made, if a sequence is started to vary the engine valve timing after such a request has been actually made. In the invention, the engine valve timing is already set to a value for an increased torque when a request is made for an increased output torque, which allows the engine output to be increased within a shorter period of time after a request is made for an increased output torque.

Through these provisions, if the driver depresses the accelerator pedal to start the vehicle in a condition in which the standby operation has been completed, a torque control operation, which is separately performed by the ECU 30 and which is not shown, sets the engine target output torque to a value corresponding to the amount of accelerator pedal depressed by the driver, and the throttle valve opening, engine speed, valve timing and other operating parameters are set to the values corresponding to the driver's target output torque. In this case, thanks to the standby operation, the amount of intake air, valve timing and other operating parameters that take time in changing have already changed in a direction of greater engine output torque when the driver starts operating the accelerator pedal, and it is now necessary only to advance the engine ignition timing toward an increased output torque side to actually increase the engine output torque. Moreover, since the engine ignition timing can be instantaneously varied, the present embodiment ensures that the engine output torque increases when the driver depresses the accelerator pedal (the driver makes a request for an increased engine output torque) to get the vehicle started, thus substantially enhancing the response in torque boost when the vehicle is started.

(2) Standby Operation when the Vehicle is Accelerated from a Decelerated State

In the present embodiment, the standby operation is carried out in anticipation of the driver's operation to re-accelerate the vehicle while it is running in a decelerated state (while it is coasting) In a vehicle provided with an automatic transmission, deceleration may be in a condition in which a lockup clutch is engaged (lockup clutch ON) or in a condition in which the lockup clutch is not engaged (lockup clutch OFF). During deceleration with the lockup clutch ON, a fuel cut that stops the supply of fuel to the engine is carried out, while during deceleration with the lockup clutch OFF, the engine is run in an idle state. In the present embodiment, a different standby operation is performed depending on whether the vehicle is in deceleration with the lockup clutch ON (fuel cut) or OFF (idle). In this embodiment, after the lapse of a predetermined period of time after the standby operation has been executed, the standby operation is stopped and a fuel cut or an idle operation is performed as in ordinary deceleration.

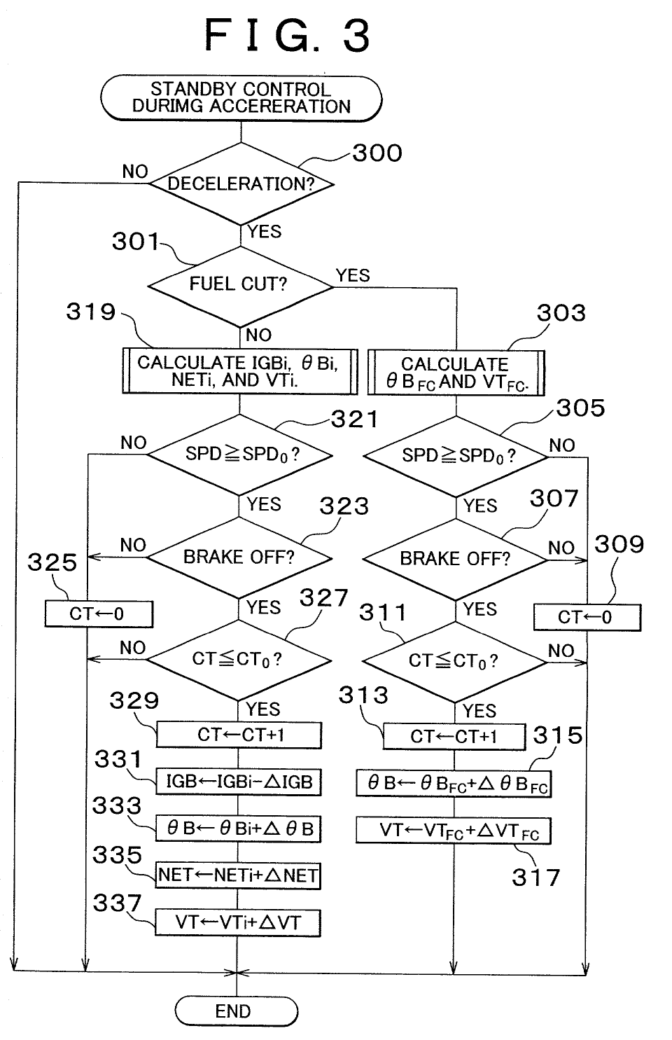

FIG. 3 is a flow chart explaining the standby operation according to the present embodiment. This operation is performed as a routine executed at predetermined time intervals by the ECU 30.

When the operation shown in FIG. 3 is started, it is determined in step 300 whether the vehicle is currently in deceleration or not. If it is determined that the vehicle is not in deceleration, the current operation is immediately terminated. In this case, the engine operating parameters are set to the values for ordinary running or idling operation. According to the present embodiment, it is determined that the vehicle is currently in deceleration in step 300 if the amount of the accelerator pedal depressed by the driver is zero and, at the same time, the vehicle is not at a standstill.

If the vehicle is determined to be in deceleration in step 300, it is then determined whether a fuel cut is being carried out or not in the subsequent step 301. If it is determined in step 301 that the fuel cut is being carried out, it follows that the vehicle is in deceleration (coasting) and, at the same time, the lockup clutch is ON. Then, the operation proceeds to step 303 in which a basic throttle valve opening θB_{FC} and a target valve timing VT_{FC} during a fuel cut are calculated using a predetermined relationship. It is further determined, in step 305, whether or not the vehicle speed SPD is a predetermined value of SPD₀ or more and, in step 307, whether the brake is currently released or not. If the current vehicle speed SPD is less than the predetermined value SPD₀ or the brake is not released, it is considered that the vehicle will likely be brought to a standstill after deceleration, which means that it is unlikely that the driver will attempt to accelerate again. Then, in this case, the operation proceeds to step 309 in which the value of an elapsed-time-after-release-of-brake counter CT is set to zero and the current operation is terminated. The value of the counter CT is incremented by one in step 313 after the operations shown in FIG. 3 have been executed, if the conditions of steps 305 to 311 are met.

If it is determined in step 305 that the current vehicle speed SPD is the predetermined value SPD₀ or more, and in step 307 that the brake is released, it is highly likely that the driver will accelerate again. Then, the operation proceeds to step 311 and it is determined whether or not the value of the counter CT has reached a predetermined value CT₀, namely, it is determined in step 307 whether or not a condition in which the brake is released continues for a predetermined period of time. If the counter does not reach the predetermined value CT₀, the standby operation for a fuel cut is executed in steps from 313 to 317.

Namely, the value of the counter CT is incremented by one in step 313 and, in step 315, the value of the basic throttle valve opening θB is set to a value of the basic throttle valve opening θB_{FC} during a fuel cut, incremented by a predetermined value ΔθB_{FC}. At the same time, the valve timing target value VT is advanced by a predetermined value ΔVT_{FC} with respect to the target value VT_{FC} during a fuel cut. This increases the amount of engine intake air and sets the valve timing on a side of an increased output.

If it is determined in step 311 that the predetermined period of time CT₀ has elapsed after the standby operation has been started, the current standby operation is terminated on the spot without allowing the operation to continue. Then, the basic throttle valve opening θB and the valve timing target value VT are set to the values for an ordinary fuel cut set in step 303 and the standby operation is terminated. The reason why the present embodiment limits the duration of the standby operation during a fuel cut within the predetermined value CT₀ is that the standby operation during a fuel cut increases the amount of engine intake air and, if the standby operation is run for a long period of time, the temperature of an exhaust emission purification catalyst disposed in the engine exhaust passage decreases, which results in exhaust emission purification performance at the end of the fuel cut being degraded.

If it is determined in step 301 that the fuel cut is not under way, then the vehicle is in deceleration and the lockup clutch is OFF. The engine is therefore running at idle speeds and, in step 319, the basic ignition timing IGBi, the basic throttle valve opening θBi, the target engine speed NETi and the valve timing VTi during the idle operation are set. In the steps from 321 to 327, the same operations as those during a fuel cut (from step 305 to step 311) are performed. If the current vehicle speed SPD is at or less than the predetermined value SPD₀ (step 321) and the brake is released (step 323), the standby operation of the steps from 329 to 337 is executed until the predetermined period of time CT₀ elapses.

Namely, in this case, the basic ignition timing IGB is retarded by the predetermined value ΔIGB with respect to the basic ignition timing during idling IGBi to limit the engine output during the standby operation (step 331) and the basic throttle valve opening θB is augmented by the predetermined value ΔθB with respect to the basic throttle valve opening during idling θBi to increase the amount of engine intake air (step 333). The target idle speed NETi is augmented by the predetermined value ΔNET over the target engine speed during idling and the amount of engine intake air is increased as the hydraulic pressure for driving the variable valve timing device increases (step 335). The valve timing VT is advanced by the predetermined value ΔVT with respect to the target valve timing value during idling VTi, thus changing toward a side for an increased output torque.

In the idling operation during deceleration, if it is determined in step 327 that the condition after the brake has been released continues for the predetermined period of time CT₀, the standby operation from step 329 to step 337 is not executed. In this case, the basic ignition timing IGB, the basic throttle valve opening θB, the target engine speed NET and the valve timing VT of the engine are set to the values for idling operation set in step 319, namely, IGBI, θBi, NETi and VTi. The reason why the duration of the standby operation is limited also in the idling operation during deceleration is that it is not preferable to continue the standby operation for an extended period of time for the following reason. That is, in the standby operation, the ignition timing is retarded to control the increase in the output torque, while maintaining the engine operating parameters more on the side of a higher output, which increases the amount of fuel consumption of the engine.

Performing the standby operation shown in FIG. 3 allows the engine operating parameters to be adjusted in anticipation of re-acceleration, regardless of whether the lockup clutch is ON (fuel cut) or OFF (idle) during deceleration. This allows the engine output torque to be boosted in a highly responsive manner when the driver depresses the accelerator pedal to start acceleration.

In the present embodiment, the request for an engine output torque change is made to augment the engine output torque and, if it is anticipated that the driver will make a request for an engine output torque change while a fuel cut that stops the supply of fuel to the engine is being executed, the standby operation is executed by increasing the amount of engine intake air among other engine operating parameters.

Namely, if it is anticipated that the driver will make a request for an increased engine output torque while a fuel cut is being executed during deceleration, the amount of engine intake air is increased. If, for example, the engine is to be re-accelerated from a decelerated state, it is therefore possible to augment the engine output torque within a shorter period of time after the driver has made a request for an increased output torque, since the amount of engine intake air is already greater than before the request is actually made by the driver.

In the present embodiment, it is estimated that the request for an engine output torque change by the driver is made when the automatic transmission is placed in the running range while the vehicle is at a standstill and, at the same time, the vehicle brake is released.

Namely, it is anticipated that there will be a request made by the driver for an engine output torque change when the driver performs a preparatory operation for getting the vehicle started while the vehicle remains stationary. That is, in a vehicle provided with an automatic transmission, the driver, in an attempt to start the vehicle, first places the automatic transmission in the running range with the brake applied, and then releases the brake and starts depressing the accelerator pedal. If the automatic transmission is placed in the running range with the vehicle remaining stationary and, at the same time, the brake is released, then it is safe to anticipate that the accelerator pedal will be depressed, that is, the driver will make a request for an increased engine output torque immediately after the foregoing operations. In the present embodiment, by anticipating a request for an increased output torque, the engine output torque can be augmented within a shorter period of time when starting the vehicle, offering good acceleration.

If there is no request made by the driver for an engine output torque change during a predetermined period of time after the standby operation has been initiated, the values of the engine operating parameters that have been changed through the standby operation may be returned to the original values set before the standby operation.

Namely, the standby operation is aborted if the expected request for an engine output torque change is not actually made by the driver during the predetermined period of time. For example, if the amount of engine intake air is increased or the ignition timing is retarded through the standby operation, it could result in the engine fuel consumption being aggravated as compared with the case in which the standby operation is not performed. Running the standby operation for an extended period of time in actual operations is not therefore preferable. According to the present embodiment, therefore, the standby operation is aborted if there is no request for torque change actually made within the predetermined period of time, namely, if the standby operation continues for the predetermined period of time. Then the engine is run in the condition present before the standby operation was made, thereby preventing the fuel consumption of the engine from being aggravated.

(3) Standby Operation when a Gearshift Operation is Performed

The standby operation when a gearshift operation is performed will next be explained. When a gearshift operation is performed in the automatic transmission, the engine output torque must be subjected to a relatively sudden change before and after the operation. In the present embodiment, a torque change operation that changes the engine output torque is performed during the gearshift operation of the automatic transmission and, to ensure that the engine output torque can be abruptly changed during the gearshift operation, the standby operation is performed before starting the gearshift operation, thereby allowing the engine output torque to be changed within a shorter period of time during the gearshift operation. Namely, in the present embodiment, if the conditions for executing a gearshift operation for the automatic transmission are met, instead of immediately starting the gearshift operation, a delay of a predetermined period of time is introduced before starting the gearshift operation and, during that period, the standby operation is carried out. This improves the response of the engine output torque to change during the gearshift and prevents a torque shock and aggravated acceleration before and after the gearshift.

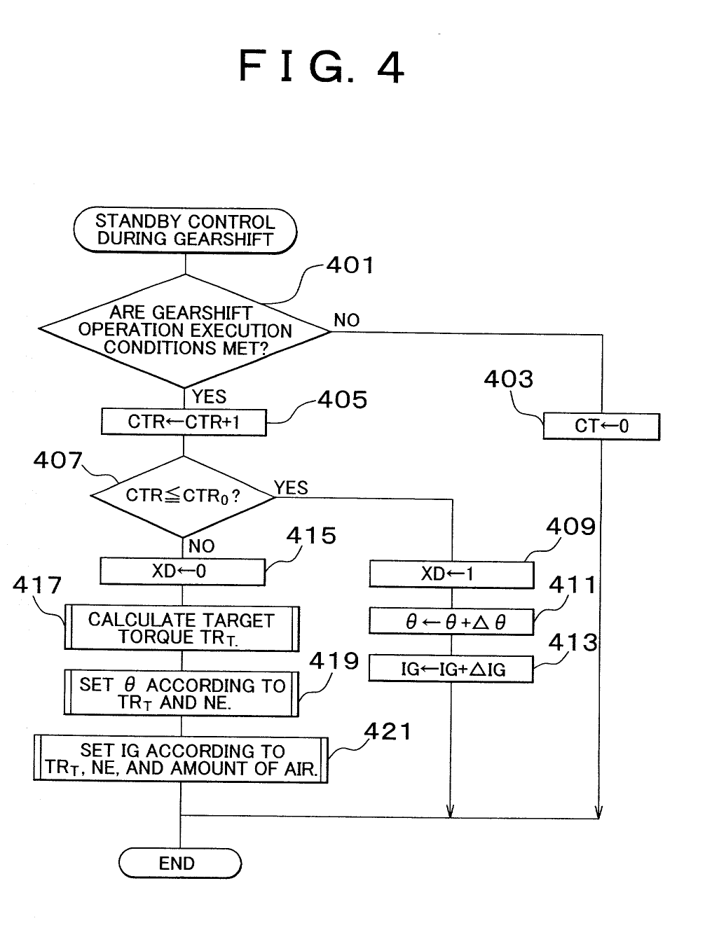

FIG. 4 is a flow chart explaining the standby operation during a gearshift operation according to the present embodiment. This operation is performed as a routine executed at predetermined time intervals by the ECU 30.

When the operation shown in FIG. 4 is started, it is determined whether or not the conditions for executing a gearshift operation of the automatic transmission are met in step 401. According to the present embodiment, a gearshift operation of the automatic transmission is executed based on, for example, the amount of the accelerator pedal depressed by the driver and the vehicle speed. The conditions for executing a gearshift operation are met when the amount of the accelerator pedal depressed by the driver and the vehicle speed have a predetermined relationship. If it is determined that the conditions for executing a gearshift operation are not met in step 401, the operation proceeds to step 403 in which the value for a gearshift delay counter CTR to be described later is set to 0.

If it is determined that the conditions for executing a gearshift operation are met in step 401, the gearshift delay counter CTR is counted up in the subsequent step 405. Since the value of the gearshift delay counter CTR is incremented by one as long as it is determined in step 401 that the conditions for executing a gearshift operation are met, the value of the gearshift delay counter CTR represents the elapsed time since the conditions for executing a gearshift operation were met.

In step 407, it is determined whether or not the value of the counter CTR has reached a predetermined value CTR₀, namely, whether or not a predetermined delay time after the conditions for executing a gearshift operation have been met has elapsed.

In the present embodiment, if it is determined in step 407 that the predetermined delay time has not elapsed, then step 409 is executed and the value of a gearshift operation delay flag XD is set to 1. When the flag XD is set to 1, a gearshift control operation separately performed by the ECU 30 inhibits the execution of a gearshift operation of the automatic transmission. Namely, even if the conditions for executing a gearshift operation are met, the gearshift operation is not actually executed as long as the value of the flag XD is set to 1.

In the subsequent steps of 411 and 413, a standby operation in preparation for the gearshift operation is performed. In the standby operation according to the present embodiment, the throttle valve opening θ is first corrected by Δθ in step 411. The value Δθ represents a correction amount set based on a predetermined relationship established according to a shift direction (shift up or shift down) in the gearshift operation execution conditions met in step 401 and the current engine speed.

In step 413, likewise, the engine ignition timing IG is corrected by ΔIG. The value ΔIG represents an ignition timing correction amount intended for controlling fluctuations in the engine output torque arising from a change made in the amount of intake air as a result of the throttle valve opening θ corrected in step 411. For example, if the throttle valve opening θ is corrected to a larger value in step 411, the value of ΔIG is set to a negative value (retarded) corresponding to the value of Δθ so as to control the increase in the output torque resulting from the increased amount of intake air.

Namely, in steps 411 and 413, the engine operating parameter that takes time in changing, that is, the amount of intake air, is changed so as to obtain the engine output torque target value to be achieved after the gearshift operation is completed and, at the same time, the engine ignition timing is changed in a direction of controlling fluctuations in the engine output torque arising from the change made in the amount of intake air.

The standby operation in steps 411 and 413 is executed until the value of the delay counter CTR reaches CTR₀. Namely, in the present embodiment, a gearshift operation is not executed as soon as the gearshift operation execution conditions are met; instead, the gearshift operation is delayed for the predetermined period of time of CTR₀ and, during such period, the amount of engine intake air is changed so as to approach the condition established after the gearshift operation.

When the predetermined period of delay time elapses (step 407) while the standby operation is being executed, the gearshift operation delay flag XD is set to 0 in step 415. When the delay flag XD is set to 0, the gearshift control operation separately performed by the ECU 30 sends a gearshift command signal to the automatic transmission 40 and the gearshift operation is executed.

Steps 417 to 421 show a torque control provided while the gearshift operation is being executed.

In step 417, the value of the gearshift control counter is used to calculate the elapsed time since the gearshift operation was actually started. The engine output torque TR_{T} required during the gearshift operation (target output torque during gearshift) is calculated based on this elapsed time, the gearshift mode (gear position, shift up or shift down, etc.), and the engine speed. The target torque during gearshift TR_{T} is, for example, a target torque value after the gearshift operation has been completed, to which a value of torque required for increasing or decreasing the engine speed in accordance with the gearshift operation is added.

In step 419, the throttle valve opening θ is set based on the target output torque during gearshift TRT set above and the engine speed. In step 421, the engine ignition timing is set based on the target output torque during gearshift TR_{T}, the amount of engine intake air, and the engine speed.

Namely, in the present embodiment, when a gearshift operation is to be executed, the gearshift operation is delayed for a predetermined delay time, during which the amount of engine intake air, which is slow to respond, is varied, thus ensuring that the amount of engine intake air reaches a level close to that of the full requirement when the gearshift operation is actually started. During the gearshift operation, the ignition timing, which is quick to respond, is controlled (step 421) so as to obtain the target output torque according to the actual engine speed, the amount of engine intake air and the target output torque TR_{T}, which allows the engine output torque to be controlled highly accurately to the target output torque when the gearshift operation is completed.

According to the present embodiment, the standby operation is performed by using the amount of engine intake air as the engine operating parameter having a low response and the ignition timing as the engine operating parameter having a high response. The engine valve timing may be used instead of, or in addition to, the amount of engine intake air as the engine operating parameter having a low response. Likewise, the amount of fuel injected may be used instead of, or in addition to, the engine ignition timing as the engine operating parameter having a high response.

According to this invention, by varying engine operating parameters in anticipation of a request for an engine output torque change, a common effect can be obtained that allows the engine output torque to be varied within a shorter period of time when the request for an engine output torque change is actually made.

Obviously, numerous modifications and variations of the present invention are possible in light of the above teachings. It is therefore to be understood that the invention may be practiced otherwise than as specifically described herein.

What is claimed is:

1. A control system for an internal combustion engine, comprising:
a torque control device adapted to control an engine output torque in accordance with an engine output torque request made by a driver, by varying an engine operating parameter that determines the engine output torque in accordance with the engine output torque request; and
a standby execution device adapted to anticipate in advance the engine output torque change request made by the driver, based on engine operating conditions and, when the engine output torque change request is anticipated, to perform a standby operation in which the value of at least one of the engine operating parameters is varied before the output torque change request is actually made.

2. The control system according to claim 1, wherein:
the engine output torque change request is a request for augmenting the engine output torque and the standby execution device performs the standby operation by retarding an engine ignition timing and by increasing an amount of engine intake air.

3. The control system according to claim 1, wherein:
the engine output torque change request is a request for augmenting the engine output torque and the standby execution device performs the standby operation by increasing an engine speed.

4. The control system according to claim 1, wherein:
the engine output torque change request is a request for augmenting the engine output torque and the standby execution device performs the standby operation by changing an engine valve timing to an engine valve timing at increase of the engine output torque.

5. The control system according to claim 1, wherein:
the standby execution device anticipates that the engine output torque change request will be made by the driver when the vehicle speed is less than a predetermined value or the brake is released.

6. The control system according to claim 1, wherein:
the engine output torque change request is a request for augmenting the engine output torque and the standby execution device is adapted to perform the standby operation by increasing the amount of engine intake air when the standby execution device anticipates that the engine output torque change request will be made by the driver while a fuel cut operation that stops the supply of fuel to the engine is being executed.

7. The control system according to claim 6, wherein:
the standby execution device is adapted to terminate the standby operation when a predetermined period of time elapses after the standby operation was initiated.

8. The control system according to claim 1, wherein:
the internal combustion engine is mounted in a vehicle provided with an automatic transmission and the standby execution device is adapted to anticipate that the engine output torque change request will be made by the driver when the automatic transmission is placed in a running range and, at the same time, the vehicle brake is released while the vehicle remains at a standstill.

9. The control system according to claim 8, wherein:
the standby execution device is adapted to delay a gearshift operation of the automatic transmission for a predetermined period of time, and to perform the standby operation during that predetermined period of time, when gearshift operation execution conditions for the automatic transmission are met.

10. The control system according to claim 9, wherein:
the standby execution device is adapted to determine that the gearshift operation execution conditions are met according to the relationship between the amount of an accelerator pedal depressed by the driver and the vehicle speed.

11. The control system according to claim 1, wherein:
the standby execution device is adapted to return the values of the engine operating parameters that have been changed through the standby operation to the original ones set before the standby operation if there is no request made by the driver for an engine output torque change during a predetermined period of time after the standby operation has been initiated.

12. A control system for an internal combustion engine, comprising:
a torque change device adapted to perform a torque change operation that changes an engine output torque by varying, according to an engine output torque change request made by a driver, a plurality of engine operating parameters that determine the engine output torque;
wherein the engine operating parameters include a first engine operating parameter that is changed within a short period of time in response to a change command issued by the torque change device and a second engine operating parameter that requires a longer period of time to change than said short period of time;
wherein the torque change device is adapted to perform, in advance of the torque change operation, a standby operation that changes the second engine operating parameter according to the engine output torque change request made by the driver and thereafter causes the first engine operating parameter to start changing, and at the end of the torque change operation, completing the change in the first engine operating parameter and the second engine operating parameter, thereby controlling the engine output torque at the end of the torque operation to a value corresponding to the engine output torque change request.

13. The control system according to claim 12, wherein:
the internal combustion engine transmits torque to an output shaft via a transmission device and the torque change operation is executed when a gearshift operation is performed on the transmission device.

14. The control system according to claim 12, wherein:
the first engine operating parameter is at least one of an engine ignition timing or an amount of fuel injected, and the second engine operating parameter is at least one of an amount of engine intake air or the engine valve timing.

15. A control method for an internal combustion engine that controls an engine output torque according to an engine output torque request made by a driver by changing an engine operating parameter that determines the engine output torque in accordance with the engine output torque request made by the driver, the method comprising the steps of:
anticipating that the driver will make an engine output torque change request based on engine operating conditions; and
when it is anticipated that the driver will make an engine output torque change request, performing a standby operation in which the value of at least one of engine operating parameters is changed in advance, before the engine output torque change request is actually made.

16. The control method according to claim 15, wherein:
in the anticipating step, an engine output torque change request is anticipated when the vehicle speed is less than a predetermined vehicle speed or the brake is released; and
in the standby operation step, at least the engine ignition timing or the amount of fuel injected is changed as the engine parameter.

17. A control method for an internal combustion engine which performs a torque change operation that changes an engine output torque by changing a plurality of engine operating parameters that determine the engine output torque according to an engine output torque request made by a driver, wherein the engine operating parameters include a first engine operating parameter that can be changed within a short period of time in response to a change command issued by a torque change device and a second engine operating parameter that requires a longer period of time to change than said short period of time, comprising the steps of:
performing, in advance of the torque change operation, a standby operation that changes the second engine operating parameter according to the engine output torque change request made by the driver; and
thereafter causing the first engine operating parameter to start changing, and at the end of the torque change operation, completing the change in the first engine operating parameter and the second engine operating parameter, thereby controlling the engine output torque at the end of the torque operation to a value corresponding to the engine output torque change request.
